(19) United States
(12) Patent Application Publication
(10) Pub. No.: US 2008/0171830 A1
(43) Pub. Date: Jul. 17, 2008

(54) Use of Silicon-Containing Polymers as Structural Adhesives

(76) Inventors: Alexander Centner, Rodersheim-Gronau (DE); Christofer Arisandy, Mannheim (DE); Dieter Flick, Bohl-Iggelheim (DE); Markus Ruckpaul, Weinheim (DE); Horst Seibert, Fussgonheim (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/913,329

(22) PCT Filed: May 2, 2006
(86) PCT No.: PCT/EP2006/061959

§ 371 Date: Nov. 1, 2007

(30) Foreign Application Priority Data
May 3, 2005 (DE) 10 2005 021 017.1

(51) Int. Cl. C08L 83/00

(52) U.S. Cl. 524/588

(57) ABSTRACT

The present invention relates to adhesives comprising at least one silicon-comprising copolymer of C₁-C₂₀-alkyl (meth)acrylates and at least one ethylenically unsaturated acid anhydride or one ethylenically unsaturated dicarboxylic acid whose carboxyl groups can form an anhydride group, or mixtures thereof, or at least one monomer comprising an isocyanate group and capable of free radical copolymerization.

The present invention relates to adhesives comprising at least one silicon-comprising copolymer of C₁-C₂₀-alkyl (meth)acrylates and at least one ethylenically unsaturated acid anhydride or one ethylenically unsaturated dicarboxylic acid whose carboxyl groups can form an anhydride group, or mixtures thereof, or at least one monomer comprising an isocyanate group and capable of free radical copolymerization.

The present invention furthermore relates to the preparation of this adhesive and the use thereof as a construction adhesive, in particular as parquet adhesive or assembly adhesive.

Parquet adhesives are used for the adhesive bonding of parquet to the substrate, parquet consisting of wood or wood and woodbase materials. Substantially three types of adhesive are used for the adhesive bonding of parquet:
dispersion adhesives
solvent adhesives
reaction resin adhesives

DIN281 “Parquet adhesives” describes requirements and test criteria for dispersion and solvent adhesives.

Dispersion adhesives consist of organic binders dispersed in water, inorganic fillers and necessary additives. Dispersion adhesives set by diffusion and evaporation of the water. The water from these adhesives causes parquet timbers/elements to swell. A disadvantage is sensitivity to mechanical disturbances in the setting phase.

A solvent adhesive consists of dissolved organic solvents, volatile solvents, inorganic fillers and additives. They bind by diffusion and evaporation of the solvent. The solvents cause parquet timbers to swell, similarly to water from dispersion adhesives. As a result of the regulation of hazardous substances and TRGS 610 (BarbBI. Issue 5/1998), the use of adhesives having a high solvent content is greatly limited for work safety reasons.

Reaction resin adhesives consists of chemically reactive organic binders, inorganic fillers and additives and are as a rule free of water and substantially solvent-free.

A distinction should be made between one-component (1C) and two-component (2C) systems.

2C systems bind through chemical reaction of the mixed components with continuous solidification. 1C systems bind as a rule through a chemical reaction of the binder with the ambient moisture. Reaction resin adhesives usually comprise no constituents which have a swelling effect on parquet timbers.

Assembly adhesives, also referred to as construction adhesives, are compositions which, owing to their properties, are suitable for a wide range of assembly operations, especially in the building industry. However, assembly adhesives are increasingly being used also for the adhesive bonding of components, such as, for example, in vehicle, aircraft, railway car, container and boat construction, in the production of furniture or in air conditioning and ventilation technology. They have a very high initial adhesion in combination with finally good load capacity of the adhesive bond of wood, metal, ceramic, PVC and further plastic in the interior and exterior sector, but also particular capabilities with regard to the provision of gaps, adhesion spectrum and flexibility.

One use of assembly adhesives is for the rapid and durable fastening of articles to ceilings, walls and floors. Frequently, assembly adhesives are also used for repair work, and for fixing in carpet, PVC, polyolefin, rubber, cork or linoleum laying on the floor as well as in the wall region. Owing to their advantageous properties, assembly adhesives can as a rule also be used as a sealant. In the case of assembly adhesives, it is important to achieve firstly toughness and stability and secondly advantageous flow properties. Moreover, the adhesive material must be capable of bridging unevennesses in the material (bridging of gaps), must ensure a sufficient open time and must achieve high shear strengths.

In the case of the assembly adhesives, a distinction is made between four types of systems:

a) solvent-containing systems
b) reactive systems (reaction resin adhesives)
c) hotmelts
d) water-based systems (dispersion adhesives).

The use of assembly adhesives having a high solvent content should as far as possible be avoided in order to ensure the best possible work safety. Solvent-containing adhesives are moreover unpopular in the interior sector, particularly for the adhesive bonding of large areas, since annoying odors frequently occur as a result of solvent vapors being released. The advantages of the use of solvent-containing systems are that the solvent present can escape rapidly from the adhesive material and strong adhesion for assembly work can thus be achieved relatively rapidly.

Hotmelts either require special conditions/apparatuses for processing or they need a relatively long time in order to develop adequate adhesion properties for assembly work.

Water-based systems have the disadvantage of releasing the water present only slowly. The curing process of the adhesive material is therefore relatively slow. The major advantage of the water-based systems is that no annoying odors and/or health hazards occur as a result of solvents released.

Reactive systems, such as those according to the invention, have the advantage that they are water- and solvent-free systems and hence no pronounced shrinkage occurs, for example when used as an assembly adhesive.

EP 387 587 describes the preparation of the abovementioned polymers and the use thereof as sealing compounds.

EP 122 457 discloses silanized polyacrylates and the use thereof as sealing compounds or contact adhesives.

EP 199 445 describes silanized polyacrylates and the use thereof, for example in sealing compounds.

WO 02/9249 likewise discloses silanized copolymers and the use thereof as sealing compounds.

WO 95/17443 likewise describes silanized acrylate copolymers and the use thereof in sealing compounds.

However, none of the documents of the prior art discloses the use of silicon-comprising polymers for construction adhesives, in particular for parquet or assembly adhesives.

An object of the present invention was the development of an adhesive which is distinguished by a rapid buildup of strength and good shear strengths.

The object was achieved, according to the invention, by an adhesive comprising

(A) a polyacrylate resin comprising at least one silicon-comprising copolymer of
a) 80-99.9% by weight of C₁-C₂₀-alkyl (meth)acrylates (monomers A) and
b) 0.1-20% by weight of at least one ethylenically unsaturated acid anhydride or one ethylenically unsaturated dicarboxylic acid whose carboxyl groups can form an anhydride group (monomers B) or 0.1-10% by weight of at least one monomer comprising at least one isocyanate group and capable of free radical polymerization (monomer C),
c) from 0 to 30% by weight of one or more ethylenically unsaturated monomers capable of free radical polymerization (monomers D) and
d) at least one silane of the general formula I, II or III

NHR₄—R₁—Si(R₂)₃₋ₘ(R₃)ₘ (I)

SH—R₁—Si(R₂)₃₋ₘ(R₃)ₘ (II)

R₅—R₁—Si(R₂)₃₋ₘ(R₃)ₘ (III)
where
m is the number 0, 1 or 2,
R₁ is a hydrocarbon chain having up to 10 carbon atoms which may be interrupted by oxygen or nitrogen
R₂ are identical or different hydrolyzable groups and
R₃ are identical or different C₁-C₅-alkyl groups,
R₄ is a hydrogen radical or a hydrocarbon chain having up to 10 carbon atoms which may comprise oxygen or nitrogen and
R₅ is an epoxide radical

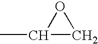

or a 3,4-epoxycyclohexyl radical,
   (B) fillers,
   (C) further conventional assistants and
   (D) 0-60% by weight of plasticizers.

The invention furthermore relates to the preparation of the adhesives according to the invention and the use thereof in construction adhesives, in particular in parquet or assembly adhesives. Moreover, the adhesives disclosed may be used as foam adhesive/impregnation, film adhesive or kneading material and as binders for coatings, tile adhesives and for footfall sound insulations.

The copolymers used according to the invention are distinguished by a rapid buildup of strength without the compulsory presence of a catalyst. In addition, elimination of methanol is avoidable with the use of silanes having R2 or R3=ethoxy.

Monomers A advantageously incorporated as polymerized units are esters of acrylic acid or methacrylic acid which are derived from alcohols comprising 1 to 10 carbon atoms, such as methanol, ethanol, isopropanol, n-butanol, isobutanol, n-pentanol, n-hexanol and 2-ethylhexanol, methyl methacrylate, methyl acrylate, n-butyl acrylate, ethyl acrylate, lauryl acrylate and 2-ethylhexyl acrylate being mentioned by way of example, preferably butyl acrylate and ethylhexyl acrylate. The monomers can be used individually or as mixtures.

The monomers A are used in amounts of 50-99.9% by weight, preferably 80-99.9% by weight.

The monomers D are auxiliary monomers which can be used in order to establish a certain rigidity of the polymers. Monomers D which may be used are, for example, acrylonitrile or methacrylonitrile, acrylamide, vinyl esters of C₂-C₁₂-n-alkanoic acids, such as vinyl acetate and vinyl propionate, and vinylaromatic monomers, such as styrene, vinyltoluene, chlorostyrene or tert-butylstyrene, acrylonitrile and methacrylontrile and styrene being preferred. Ethylenically unsaturated carboxylic acids, such as, for example, acrylic acid, methacrylic acid or itaconic acid, can also be used.

The monomers D are used in amounts of from 0 to 30% by weight.

The parts by weight of the monomers A, D are advantageously chosen with the aid of the Fox relationship so that a polymer composed only of these monomers would have a glass transition temperature of from −70 to +15, preferably from −50 to −10, ° C. According to Fox (T. G. Fox, Bull. Am. Phys. Soc. [Ser. II], 1, 123 [1956]) the following is a good approximation for the glass transition temperature of the copolymers

1/T_{g}=x/T_{g}¹+x²/T_{g}²+ . . . xⁿ/T_{g}ⁿ

where x¹, x², . . . , xⁿ are the mass fractions of the monomers 1, 2, . . . , n and T_{g}¹, T_{g}², . . . , T_{g}ⁿ are the glass transition temperatures of the polymers composed in each case only of one of the monomers 1, 2, . . . or n, in degrees Kelvin.

The glass transition temperatures of these homopolymers of the monomers A and D are known and are mentioned, for example, in J. Brandrup, E. H. Immergut, Polymer Handbook 1^{st} Ed. J. Wiley, New York, 1966 and 2^{nd} Ed. J. Wiley, New York, 1975.

Advantageously used monomers B, which are preferred over the monomers C, are cyclic anhydrides of dibasic acids, such as maleic anhydride, itaconic anhydride or citraconic anhydride, maleic anhydride being particularly preferably used. The monomers B are used in amounts of 0.1-20% by weight, preferably 0.5-15% by weight, particularly preferably 1-10% by weight.

Suitable monomers C are, for example, ω-isocyanatoalkyl acrylates and methacrylates of the general formula II

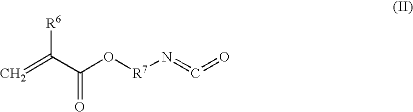

where the variables have the following meaning:
R⁶ is hydrogen or methyl
R⁷ is a hydrocarbon chain having up to 12 carbon atoms which may be interrupted once or several times by oxygen,
   which are described, inter alia, in DE-A 35 23 692. Further possible monomers C are N-(1-alkenyl)isocyanates having 2 to 4 carbon atoms in the alkenyl group, and 1-(4-isoprenylphenyl)-1-methylethyl isocyanate and the adduct of bis[isocyanato]carbodiimide and acrylic acid. The last two monomers are described, inter alia, in “Methoden der organischen Chemie (Houben-Weyl)”, E20, pages 1573 to 1575, Georg Thieme Verlag, Stuttgart (1987). Preferred monomers C are vinyl isocyanate, 2-isocyanatoethyl 2-methylacrylate, 5-isocyanato-3-oxapentyl 2-methylacrylate and 1,2-dimethyl-3-isocyanatopropyl acrylate.

Halogens, the amino group or alkoxy, alkylthio, alkylamino or dialkylamino groups carrying few carbon atoms are among the preferred hydrolyzable groups R₂. The alkyl groups are understood as meaning alkyl radicals comprising 1 to 5 carbon atoms, for example the methyl, ethyl, propyl, n-butyl, isobutyl or pentyl radical.

A hydrocarbon chain having up to 12 carbon atoms which may be interrupted once or several times by oxygen may be an ethyl, propyl, butyl, tert-butyl, pentyl, hexyl, octyl, nonyl, decyl, dodecyl or undecyl chain.

A hydrocarbon chain having up to 10 carbon atoms which may comprise nitrogen or oxygen may be a methyl, ethyl, propyl, n-butyl or tert-butyl radical for R₄; it may also be an aminoalkyl, a dialkyl maleate radical, a cyclohexyl or phenyl radical for R₄ and a propyl or 2,2-dimethylbutyl radical for R₁ and a CH₂ radical for the group of the α-silanes.

Preferably used silanes I are 3-aminopropyltrimethoxysilane, 3-aminopropyltriethoxysilane, N-(2-aminoethyl-3-aminopropyl)trimethoxysilane, 3-aminopropylmethyldiethoxysilane, 4-amino-3,3-dimethylbutyltrimethoxysilane, N-(n-butyl)-3-aminopropyltrimethoxysilane, 1-butanamino-4-(dimethoxymethylsilyl)-2,2-dimethyl, (N-cyclohexylaminomethyl)triethoxysilane, (N-cyclohexylaminomethyl)-methyldiethoxysilane, (N-phenylaminoethyl)trimethoxysilane, (N-phenylaminomethyl)-methyldimethoxysilane or γ-ureidopropyltrialkoxysilane.

Mercaptosilanes of the general formula II are, for example, 3-mercaptopropyltrimethoxysilane, 3-mercaptopropylmethyldimethoxysilane or 3-mercaptopropyltriethoxysilane. The epoxysilanes of the general formula III are understood as meaning, for example, 3-glycidyloxypropyltrimethoxysilane, 3-glycidyloxypropyltriethoxysilane or beta-(3,4-epoxycyclohexyl)ethyltrimethoxysilane.

The content of silanes I, II or III in the polymer according to the invention is dependent on the content of monomers B or C. Thus, the content of silanes is such that the quotient Q, calculated from the number of moles of the incorporated silanes as the numerator and the number of moles of the incorporated monomers B or the isocyanate groups incorporated in the form of the monomers C as the denominator, is from 0.1 to 1, preferably from 0.5 to 1, particularly preferably from 0.8 to 1.

The polymers according to the invention are outstandingly suitable as a basis for adhesives, in particular for construction adhesives, such as parquet adhesives and assembly adhesives.

The preparation of the polymers according to the invention is expediently effected by a procedure in which a starting polymer is prepared from the monomers A to D by the free radical solution polymerization method known per se and the silanes I are stirred into the solution or melt thereof, usually within a few minutes; the temperature is of minor importance and may be from 25 to 120°. Solvents used for the free radical solution polymerization are as a rule ethers, such as tetrahydrofuran or dioxane, esters, such as ethyl acetate or n-butyl acetate, ketones, such as acetone and cyclohexanone, methyl ethyl ketone (MEK), N,N-dialkylcarboxamides, such as N,N-dimethylformamide, N,N-dimethylacetamide or N-methyl-2-pyrrolidone, aromatics, such as toluene and xylene, aliphatic hydrocarbons, such as isooctane, chlorinated hydrocarbons, such as tert-butyl chloride, or plasticizers, such as di-n-butyl phthalate.

Particularly suitable free radical initiators are organic azo compounds or organic peroxides, such as azobisisobutyronitrile, dibenzoyl peroxide, tert-butyl perpivalate, tert-butyl peroctanoate, tert-butyl perneodecanoate, tert-butyl perisononanoate, tert-amyl perpivalate and tert-butyl perbenzoate.

Water scavengers, catalysts or chain transfer substances, such as aliphatic, aromatic or alicyclic mercaptans, e.g. n-butyl mercaptan, n-lauryl mercaptan or tert-dodecyl mercaptan, or alkyl thioglycolates, such as ethyl thioglycolate, or terpinolenes, may be added as further assistants. Particularly preferred molecular weight regulators are tert-dodecyl mercaptan, terpinolene or mercaptoalkoxysilanes.

The polymerization temperature is advantageously from 70 to 160° C. Usually, the polymerization is carried out in the form of a feed process in which a part of the polymerization batch is initially taken and heated to the polymerization temperature and then, while maintaining the polymerization temperature, the remainder of the polymerization batch is fed in continuously in separate feeds, one of which comprises the monomers. The feed process usually takes a time of from 2 to 24 h. Finally, postpolymerization is usually effected for a further 1 to 2 h. An “anhydrous” polymerization medium is expediently employed, i.e. a water content of less than 100 ppm. The solution polymerization of the essentially anhydrous reactants is advantageously carried out in the presence of small amounts of drying agents, such as tetraalkoxysilanes, e.g. tetramethoxysilane, or trialkyl orthoformates, e.g. triethyl orthoformate, if appropriate with addition of a Lewis acid. Solvent can if required be partly or completely separated from the resulting solutions of the starting polymers, for example, distillation under reduced pressure.

The K value of the resulting starting polymers in tetrahydrofuran (THF) is preferably from 1 to 100, particularly preferably from 1 to 30, especially preferably from 5 to 20. The K value is a relative viscosity number which is determined analogously to DIN 53726 at 25° C. It comprises the flow rate of a mixture of 0.01 g of polymer per mole of THF, relative to the flow rate of pure THF, and characterizes the average degree of polymerization of the polymer.

By stirring the silanes I, II or III into the melts or solutions of the starting polymers, the polymers according to the invention are obtainable as such or in solution, the reaction with the silanes II or II generally being effected at as low as room temperature, whereas temperatures greater than 100° C. are required in the case of the reaction of the silanes III.

In the preparation of the adhesives according to the invention, inter alia external plasticizers, inert fillers, surface-modified fillers, pigment distributors, rheology additives, thixotropic agents, thickeners, adhesion promoters, water scavengers, dyes, solvents, fireproofing additives, agents for increasing the aging resistance or active substances which accelerate the curing by the action of atmospheric humidity can be added as assistants.

The amounts of additives are familiar to the person skilled in the art and are chosen as a function of the desired properties of the adhesive and expediently stirred into the solutions or melts of the polymers according to the invention or directly into the polymers. The proportion of the silicon-comprising polymers according to the invention is as a rule from 20 to 100, preferably from 30 to 70, % by weight, based on the total weight of the formulation.

Suitable fillers or pigments are mentioned, for example, in “Pigment-und Fullstoff-Tabellen”, Lückert, (2002), Vincentz Verlag.

Suitable inert fillers are in particular aluminum silicates, quartz, precipitated or pyrogenic silica, which may have been rendered hydrophobic, calcium sulfate dihydrate and barite, talc, dolomite, calcium carbonate and color-imparting pigments, such as titanium white, lead white, chrome yellow, red lead, zinc yellow or carbon black and also calcium silicate, barium sulfate, magnesium carbonate and magnesium silicate. Some of the fillers advantageously have an additional reinforcing effect by means of which, for example, the cohesion of the adhesives can be increased.

Suitable further inorganic filler particles are, for example, filler particles comprising andalusite, silimanite, kyanite, mullite, pyrophylite, omogolite or allophane. Compounds based on sodium aluminates, silicates, such as, for example, aluminum silicates, calcium silicates or silicas (e.g. Aerosil®), are furthermore suitable. Minerals such as silica, calcium sulfate (gypsum), which does not originate from stack gas desulfurization plants, in the form of anhydrite, hemihydrate or dihydrate, quartz powder, silica gel, precipitated or natural barium sulfate, titanium dioxide, zeolite, leucite, potash feldspar, biotite, the group consisting of the soro-, cyclo-, ino-, phyllo- and tectosilicates, the group consisting of the sparingly soluble sulfates, such as gypsum, anhydrite or barite, and calcium minerals, such as calcite, are likewise suitable.

Said inorganic materials can be used individually or as a mixture. Further suitable materials are precipitated or natural kaolin, talc, magnesium hydroxide or aluminum hydroxide (for establishing the fire class), expanded graphite, sheet silicates, zinc oxide and zirconium salts. Parameters such as dimensional stability and density can be influenced by addition of light fillers—hollow ceramic microspheres, hollow glass spheres, foam glass spheres, expanded or unexpanded polystyrene and other light fillers, as produced, for example, by Omega-Minerals.

The filler particles have a ×50 value for the average particle size distribution of from about 1 to 120 μm, for example from about 3 to 60 or from about 60 to 90 μm, measured with Sympatec® Helos H 0720 in isopropanol.

Also suitable for use are organic filler particles. These include in particular finely milled plastic powders, as may occur in the recycling of plastics, and plastic powders as are obtainable from the fine milling of highly crosslinked elastomeric or thermosetting polymers. An example of this is rubber powder, as formed, for example, by fine milling of car tires. Further filler particles are plastic fibers, impact modifiers, cellulose fibers and glass fibers (e.g. Wollastonit® brands).

The pigments serve for coloring the adhesive or assembly adhesive. Organic pigments and iron oxides are preferred. Examples are the Luconyl® grades from BASF. The pigments are used in amounts of from 0 to 5% by weight, preferably from 0.5 to 2% by weight.

Suitable plasticizers are in general all types which are compatible with the polymer, e.g. adipates, phthalates, sebacates, phosphoric esters, dicarboxylates, citrates, chlorinated or unchlorinated hydrocarbon plasticizers or soft resins.

Propylene glycol alkylphenyl ether, ethylene glycol phenyl ether, polyisobutylenes, phthalic esters and/or sulfonic esters, benzenesulfonamides, resin melts (comprising natural and synthetic resins) with Pluriols or plasticizers, phosphate esters, di-2-ethylhexyl sebacates (DOS) and di-2-ethylhexyl azelates (DOZ), diisodecyl sebacates (DIDS), tris-2-ethylhexyltrimellitates (trioctyl trimellitates—TOTM), L79TM (an ester of mixed semilinear C₇- and C₉-alcohols) and L810TM, an ester of mixed C8 and C10 linear alcohols, or epoxidized soybean oil (ESBO) and epoxidized linseed oil (ELO) are used as plasticizers, for example in an amount of from 0 to 60% by weight. However, the use of plasticizers is preferably dispensed with.

Fatty alcohols or derivatives thereof may furthermore be used, in particular triglycerides of higher fatty acids and preferably natural fats and oils.

Phthalates (Palatinol grades), adipates (Plastomoll® grades), dicarboxylates (e.g. Hexamoll® DINCH), citrates or soft resins (e.g. acResin® DS 3500, Acronal® 4 F) may be used as further plasticizers.

The further assistants include, for example, solvents for influencing the open time and the mechanical properties, e.g. butylglycol. Rosin- or hydrocarbon-based resins may be used as tackifiers. Further assistants may be crosslinking agents, adhesion promoters, pigment distributors, antisettling agents and stabilizers. Adhesion promoters which may be used are, for example, silanes, such as vinyltrimethoxysilane, glycidyloxypropyl-trimethoxysilane, aminopropyltriethoxysilane or bis(trialkoxysilylpropyl)amine. The adhesion to certain substances can be further improved by the use of primers.

Further conventional assistants are rheology additives. An overview is to be found in “Lackrohstoff-Tabellen”, Karsten, 10th Edition, Vincentz Verlag, page 856 et seq. These include inorganic and organic thickeners or thixotropic agents, such as, for example, but not exclusively, kaolins, sheet silicates, such as smectites, bentonites, hectorite (e.g. Bentone® 27, from Elementis), modified alkyd resins (Borchi® Set 134, from Borchers), modified ureas (Byk® 410, Byk Chemie), polyamide waxes (Crayvallac® SLX, Crayvallac® Super, from Cray Valley, Disparlon® 6100, C. H. Erbslöh), vegetable oil derivatives (Polytix® R100, from CF), modified castor oil derivatives (Thixatrol® ST, from Elementis, Flowtone® ST, from Cray Valley), fatty acid amides (Lutovix® HP, Lehmann & Voss) and fibrous fillers (e.g. polyethylene fibers, such as Stewathix® 100/200/500/600, from STW). Precipitated or pyrogenic silicas, which may have been rendered hydrophobic, are furthermore suitable as rheology additives (e.g. Aerosil® 300, from Degussa or water repellent grades, e.g. Aerosil® R 106, from Degussa). Celluloses (ethylcellulose, from Herkules) and derivatives thereof and natural thickeners, such as, for example, bentonites, alginates or starch, may also be used as thickeners.

The polymers and formulations according to the invention are characterized by curing which progresses rapidly at as low as room temperature under the action of atmospheric humidity and, if required, can be additionally accelerated by adding appropriate catalysts.

Suitable catalysts are mentioned in “Lackrohstoff-Tabellen”, Karsten, 10th Edition, Vincentz Verlag, page 797 et seq.

For example, the following may be used as catalysts: organic or inorganic acids, e.g. p-toluenesulfonic acid, phosphoric acid and mono- and diesters thereof, salts of organic acids, e.g. tin naphthenate, tin octanoate, tin butyrate, iron stearate, tetra-n-butyl titanate, di-n-butyltin di-n-dodecanoate or di-n-butyltin diacetate or di-n-butyltin dilaurate, or organic amines, such as isophorone, imidazoles, etc. Preferred condensation catalysts are organotin salts, such as dibutyltin dilaurate and dibutyltin diacetate, organic bismuth compounds. The formulations according to the invention may comprise 0-5% by weight, preferably 0-2% by weight, particularly preferably 0-1% by weight, of these active substances.

The adhesives can be prepared in the form of a one-component system in which all constituents are mixed and then stored in a sealed container. However, they can also be used in the form of a two-component system in which the starting polymer and the assistants are mixed to give a component into which the silanes I are stirred as a second component prior to use. In the case of a one-component system, particular care must be taken to exclude water, since otherwise premature curing of the adhesives occurs. In the case of a two-component system, the presence of small traces of water in the starting polymer or in the assistants is less critical, which facilitates both the processing of the starting components and the storage of the adhesive.

The following examples are intended to explain the invention in more detail, but without restricting them thereto.

### EXAMPLES B1 TO B16 AND B18

### Various Silicon-Comprising Polymers which are Mainly Composed of Acrylic and/Methacrylic Esters

### B1

A solution of 300 g of toluene, 1 g of triethyl orthoformate and 50 g (510 mmol) of maleic anhydride was heated to the polymerization temperature of 110° C. and then, while maintaining the polymerization temperature, 550 g of n-butyl acrylate were added in the course of 2.5 h, and parallel therewith a solution of 2 g of azobisisobutyronitrile in 100 g of toluene in the course of 3.5 h. Polymerization was then continued for a further 2 h at 110° C. The K value (in THF) of the starting polymer obtained in solution was 32. 12 g (67 mmol) of 3-aminopropyltrimethoxysilane were stirred into the resulting solution of the starting polymer at room temperature in the course of 5 min. A sample of the liquid obtained was applied to a glass plate in a layer thickness of 2 mm and exposed to standard temperature and humidity conditions (23° C., 50% relative humidity). After 24 h, the film which had formed no longer showed any flow behavior.

### B2

As for B1, except that 12 g (60 mmol) of 5-isocyanato-3-oxapentyl 2-methylacrylate were incorporated as polymerized units instead of 50 g of maleic anhydride. The K value (in THF) of the starting polymers was 36.5. After 70 h, the film which had formed no longer showed any flow behavior.

### B3

A solution of 300 g of toluene and 2 g of triethyl orthoformate was heated to the polymerization temperature of 80° C. and then a monomer mixture comprising 500 g of n-butyl acrylate, 90 g of acrylonitrile and 10 g (65 mmol) of 2-isocyanatoethyl 2-methyl acrylate was added in the course of 3 h, and parallel therewith a solution of 2 g of azobisisobutyronitrile in 100 g of toluene in the course of 3.5 h. Thereafter, polymerization was continued for a further 1.5 h at 110° C. and then 150 g of solvent were distilled off under reduced pressure. 11.6 g (65 mmol) of 3-aminopropyltrimethoxysilane were then stirred at room temperature into the solution comprising a starting polymer having a K value (in THF) of 42.0, and a sample of the formulation obtained was applied to a glass plate in a layer thickness of 2 mm and exposed to standard temperature and humidity conditions for 3 weeks. A transparent resilient film having a tensile strength of 0.37 N/mm² and an elongation at break (both according to DIN 53 504 at a feed rate of 100 mm/min and with the use of the test specimen S3A) of 677% was obtained.

### B4

As for B3 but with the following differences: The polymerization temperature was 80° C., the composition of the monomer mixture was 540 g of ethyl acrylate, 50 g of acrylonitrile and 10 g (65 mmol) of 2-isocyanatoethyl 2-methylacrylate, the monomer mixture was fed in in the course of 1 h 45 min, the initiator solution comprised 3 g of azobisisobutyronitrile and was fed in parallel to the monomer mixture in the course of 2 h 30 min, the postpolymerization was effected at 90° C., the amount of solvent distilled off was 100 g, the K value of the starting polymer (in THF) was 45.9 g, 14.3 g (65 mmol) of 3-aminopropyltriethoxysilane were added as silane i, the tensile strength was 1.3 N/mm² and the elongation at break was 146%.

### B5

As for B3 but with the following differences: The polymerization temperature was 105° C., the composition of the monomer mixture was 490 g of ethyl acrylate, 100 g of n-butyl methacrylate and 12 g (77 mmol) of 2-isocyanatoethyl 2-methylacrylate, the monomer mixture was fed in in the course of 2 h, the initiator solution comprised 3 g of azobisisobutyronitrile and was fed in parallel with the monomer mixture in the course of 2 h 15 min, the postpolymerization lasted for 2 h, the amount of solvent distilled off was 100 g, the K value of the starting polymer (in THF) was 36.4 g, 14.3 g (64 mmol) of N-(2-aminoethyl-3-aminopropyl)trimethoxysilane were added as silane 1, the tensile strength was 0.36 N/mm² and the elongation at break was 345%.

### B6

As for B3, but with the following differences: The polymerization temperature was 100° C., the composition of the monomer mixture was 500 g of n-butyl acrylate, 90 g of ethyl acrylate and 15 g (75 mmol) of 5-isocyanato-3-oxapentyl 2-methylacrylate, the monomer mixture additionally comprised 2 g of ethyl thioglycolate, the monomer mixture was fed in in the course of 2.5 h, the initiator solution comprised 4 g of azobisisobutyronitrile and was fed in parallel with the monomer mixture in the course of 3 h, the postpolymerization lasted for 1 h, the solvent was completely distilled off, the K value of the starting polymer (in THF) was 21.4, the amount of 3-aminopropyltrimethoxysilane added was 12 g (67 mmol) and was added together with 2 g of di-n-butyltin di-n-dodecanoate, the tensile strength was 0.2 N/mm² and the elongation at break was 98%.

### B7

As for B3, but with the following differences: The polymerization temperature was 100° C., the composition of the monomer mixture was 590 g of ethyl acrylate and 10 g (50 mmol) of 5-isocyanato-3-oxapentyl 2-methylacrylate, the monomer mixture was fed in in the course of 2 h, the initiator solution comprised 4 g of azobisisobutyronitrile and was fed in parallel with the monomer mixture in the course of 2 h 30 min, the postpolymerization lasted for 1 h, the amount of solvent distilled off was 200 g, the K value of the starting polymer (in THF) was 26.1, the amount of 3-aminopropyl-trimethoxysilane added was 9 g (50 mmol) and was added together with 30 g of pyrogenic silica which had been rendered hydrophobic and 2 g of di-n-butyltin di-n-dodecanoate, the tensile strength was 0.8 N/mm² and the elongation at break was 110%.

### B8

As for B3, but with the following differences: The polymerization temperature was 100° C., the composition of the monomer mixture was 490 g of ethyl acrylate, 100 g of acrylonitrile and 10 g (50 mmol) of 5-isocyanato-3-oxapentyl 2-methylacrylate, the monomer mixture was fed in in the course of 2 h, the initiator solution comprised 4 g of azobisisobutyronitrile and was fed in parallel with the monomer mixture in the course of 2 h 30 min, the postpolymerization lasted for 1 h, the amount of solvent distilled off was 100 g, the K value of the starting polymer (in THF) was 39.5, the amount of 3-aminopropyltrimethoxysilane added was 9 g (50 mmol), the tensile strength was 2.3 N/mm² and the elongation at break was 550%.

### B9

As for B3 but with the following differences: The polymerization temperature was 110° C., the initially taken solution additionally comprised 10 g (102 mmol) of maleic anhydride, the composition of the monomer mixture was 510 g of ethyl acrylate, 60 g of methyl methacrylate and 20 g of styrene, the postpolymerization was effected at 130° C. and lasted for 1 h, the amount of solvent distilled off was 80 g, the K value of the starting polymer (in THF) was 37.5, the added amount of 3-aminopropyltrimethoxysilane was 18.3 g (102 mmol), the tensile strength was 1.08 N/mm² and the elongation at break was 575%.

### B10

As for B3 but with the following differences: The polymerization temperature was 110° C., the initially taken solution additionally comprised 10 g (102 mmol) of maleic anhydride, the composition of the monomer mixture was 410 g of ethyl acrylate, 160 g of methyl methacrylate and 20 g of styrene, the postpolymerization was effected at 130° C. and lasted for 1 h, no solvent was distilled off, the K value of the starting polymer (in THF) was 34, the added amount of 3-aminopropyltrimethoxysilane was 10 g (56 mmol), the tensile strength was 1.52 N/mm² and the elongation at break was 358%.

### B11

As for B3 but with the following differences: The polymerization temperature was 100° C., the initially taken mixture additionally comprised 20 g (204 mmol) of maleic anhydride, the composition of the monomer mixture was 510 g of n-butyl acrylate, 60 g of acrylonitrile and 20 g of styrene, the monomer mixture additionally comprised 2 g of ethyl thioglycolate, the initiator solution was fed in parallel with the monomer solution in the course of 3 h, the postpolymerization was effected at 100° C. and lasted for 1 h, the amount of solvent distilled off was 400 g, the K value of the starting polymer (in THF) was 30.5, the added amount of 3-aminopropyltrimethoxysilane was 10 g (56 mmol), the tensile strength was 1.32 N/mm² and the elongation at break was 363%.

### B12

As for B3 but with the following differences: The polymerization temperature was 100° C., the initially taken mixture additionally comprised 10 g (102 mmol) of maleic anhydride, the monomer mixture consisted only of 590 g of ethyl acrylate and was added in the course of 2 h, the initiator solution was fed in parallel with the monomer mixture in the course of 2.5 h, the postpolymerization lasted for 1 h, the amount of solvent distilled off was 120 g, the K value of the starting polymer (in THF) was 28.4, 10 g (45 mmol) of 3-aminopropyltriethoxysilane were added as silane 1, the tensile strength was 0.36 N/mm² and the elongation at break was 347%.

### B13

As for B3 but with the following differences: The polymerization temperature was 90° C., the initially taken mixture additionally comprised 30 g (306 mmol) of maleic anhydride, the composition of monomer mixture was 510 g of n-butyl acrylate, 60 g of acrylonitrile and 20 g of styrene, the monomer mixture was fed in in the course of 2.5 h, the initiator solution comprised 4 g of azobisisobutyronitrile and was fed in parallel with the monomer mixture in the course of 3 h, the postpolymerization lasted for 1 h, no solvent was distilled off, the K value of the starting polymers (in THF) was 36.1.12 g (54 mmol) of 3-aminopropyltriethoxysilane were added as silane 1, together with 50 g of pyrogenic silica which had been rendered hydrophobic and 1 g of di-n-butyltin di-n-dodecanoate, the tensile strength was 1.1 N/mm² and the elongation at break was 230%.

### B14

As for B3 but with the following differences: The polymerization temperature was 120° C., the initially taken mixture consisted of 370 g of di-n-butyl phthalate, 5 g of tetraethoxysilane and 20 g (204 mmol) of maleic anhydride, the composition of the monomer mixture was 710 g of ethyl acrylate and 180 g of methyl methacrylate, the monomer mixture was fed in in the course of 2.5 h, the initiator solution consisted of 5 g of tert-butyl perbenzoate and 30 g of di-n-butyl phthalate and was fed in parallel with the monomer mixture in the course of 3.0 h, the postpolymerization was effected at 120° C. and lasted for 1 h, no solvent was distilled off, the K value of the starting polymer (in THF) was 39, 14 g (63 mmol) of 3-aminopropyltriethoxysilane were added as silane 1, the tensile strength was 0.1 N/mm² and the elongation at break was 83%.

### B15

5% of a monomer mixture comprising 225 g of 2-ethylhexyl acrylate, 60 g of ethyl acrylate and 10% of an initiator solution of 8 g of tert-butyl perpivalate and 45 g of methyl ethyl ketone were heated with 228 g of methyl ethyl ketone and 15 g (153 mmol) of maleic anhydride to the polymerization temperature of 80° C., and then the remainder of the monomer mixture was added in the course of 3 h and, parallel therewith, the remainder of the initiator solution was added in the course of 3.25 h. After the end of the feeds, an initiator solution comprising 0.4 g of tert-butyl perpivalate and 30 g of methyl ethyl ketone was metered in in 5 min. Thereafter, polymerization was continued for a further 45 min at 90° C. and solvent was then distilled off under reduced pressure. The K value (in THF) of the starting polymer obtained in solution was 18.1.

### B16

5% of a monomer mixture comprising 225 g of 2-ethylhexyl acrylate, 60 g of n-butyl acrylate and 10% of an initiator solution of 8 g of tert-butyl perpivalate and 55 g of methyl ethyl ketone were heated with 219 g of methyl ethyl ketone and 15 g (153 mmol) of maleic anhydride to the polymerization temperature of 80° C., and then the remainder of the monomer mixture was added in the course of 3 h and, parallel therewith, the remainder of the initiator solution was added in the course of 3.25 h. After the end of the feeds, an initiator solution comprising 0.4 g of tert-butyl perpivalate and 30 g of methyl ethyl ketone was metered in in 5 min. Thereafter, polymerization was continued for a further 45 min at 90° C. and solvent was then distilled off under reduced pressure. The K value (in THF) of the starting polymer obtained in solution was 17.3.

### B17

5% of a monomer mixture comprising 202 g of 2-ethylhexyl acrylate, 60 g of ethyl acrylate and 38 g (153 mmol) of methacryloyloxypropyltrimethoxysilane and 10% of an initiator solution of 8 g of tert-butyl perpivalate and 53 g of methyl ethyl ketone were heated with 217 g of methyl ethyl ketone to the polymerization temperature of 80° C., and then the remainder of the monomer mixture was added in the course of 3 h and, parallel therewith, the remainder of the initiator solution was added in the course of 3.25 h. After the end of the feeds, an initiator solution comprising 0.4 g of tert-butyl perpivalate and 35 g of methyl ethyl ketone was metered in in 5 min. Thereafter, polymerization was continued for a further 45 min at 90° C. and solvent was then distilled off under reduced pressure. The K value (in THF) of the starting polymer obtained in solution was 20.0.

### B18

5% of a monomer mixture comprising 219 g of n-butyl acrylate, 60 g of ethyl acrylate and 21 g (214 mmol) of maleic anhydride and 10% of an initiator solution of 6 g of tert-butyl peroctanoate and 70 g of o-xylene were heated with 220 g of o-xylene to the polymerization temperature of 140° C., and then the remainder of the monomer mixture was added in the course of 3 h and, parallel therewith, the remainder of the initiator solution was added in the course of 3.25 h. After the end of the feeds, an initiator solution comprising 0.3 g of tert-butyl peroctanoate and 15.3 g of o-xylene was metered in in 5 min. Thereafter, polymerization was continued for a further 45 min at 140° C. and the solvent was then distilled off under reduced pressure. The K value (in THF) of the starting polymer obtained in this solution was 11.2.

### Testing of the Buildup of Strength of Patent Examples B15-B18

### Example Formulations V1-V10

| | |
|---|---|
| 50.00 g | of starting polymer (B15-B17) |
| 5.99 g | of Dynasilan 1189 (or Dynasilan AMEO, |
| | both silanes from Degussa) |
| 0.50 g | of dibutyltin dilaurate (catalyst) |
| 1.00 g | of silica 500 LS (thixotropic agent) |

The polyacrylate, the silane and the catalyst are weighed into a 150 ml PE beaker. The mixture is homogenized with the aid of a dissolver. The thixotropic agent is then weighed in and likewise homogenized with the aid of the dissolver.

### Testing of the Buildup of Strength of Example Formulations V1-V10

### Dynamic Shear Strength of Parquet Adhesives, Based on Din En 14293

The adhesive example formulation is applied by means of toothed bar TKB B 3 to an oak mosaic parquet lamella (160×23×8 mm), transversely to the longitudinal side, in the region of the area to be adhesively bonded. Immediately after spreading on, the oak mosaic parquet lamella is laid with the aid of a template in a manner such that a bonding area of 26×23 mm (˜6 cm²) forms. It should be ensured that the upper parquet lamella is positioned symmetrically and parallel to the edge of the lower parquet lamella. After positioning, the bonded area is loaded with 2 kg/6 cm² for 1 minute.

In each case 5 test specimens are stored under standard temperature and humidity conditions (at 50% relative humidity, 23° C.), as follows: A: 2 hours, B: 4 hours, C: 24 hours, D: 7 days, E: 14 days.

The dynamic shear strength is tested at a test speed of 20 mm/min using a Zwick Z010 tester (from Zwick GmbH & Co. KG, Ulm).

TABLE
Composition of the tested example formulations V1-V10

| Stated amounts | | | | | | | | | | |
|---|---|---|---|---|---|---|---|---|---|---|
| in grams | V1 | V2 | V3 | V4 | V5 | V6 | V7 | V8 | V9 | V10 |
| B15 | 50 | 50 | | | 50 | 50 | | | | |
| B16 | | | 50 | 50 | | | 50 | 50 | | |
| B17 | | | | | | | | | 50 | 50 |
| DBTL | 0.5 | 0.5 | 0.5 | 0.5 | | | | | 0.5 | |
| Dynasilan | 5.99 | | 5.99 | | 5.99 | | | | | |
| 1189 | | | | | | | | | | |
| Dynasilan | | 5.63 | | 5.63 | | 5.63 | 5.63 | 5.63 | | |
| AMEO | | | | | | | | | | |
| Silica | 1 | 1 | 1 | 1 | 1 | 1 | 1 | 1 | 1 | 1 |
| 500 LS | | | | | | | | | | |

### Example Formulation of an Adhesive P1:

| | |
|---|---|
| 300.00 g | of starting polymer B18 |
| 70.00 g | of Palatinol N (plasticizer) + 2% of EC N 100 |
| | (ethylcellulose) |
| 100.00 g | of Polycarb SB (filler) |
| 130.00 g | of Precarb 100 (filler) |
| 18.00 g | of silica 500 LS (thixotropic agent) |
| 26.66 g | of Dynasilan A 1637 (crosslinking agent) |
| 22.45 g | of Dynasilan 1505 (crosslinking agent) |
| 4.00 g | of vinyltrimethoxysilane (water scavenger) |

The starting polymer B18, the plasticizer comprising the dissolved ethylcellulose, the thixotropic agent and the fillers are weighed into the can having a press-in lid. The mixture is homogenized at high speed, the material in the can not exceeding a temperature of 60° C. The water scavenger, the adhesion promoter and the crosslinking agent are now added. The mixture is typically stirred for one hour under reduced pressure at a temperature of about 50° C.

TABLE
Results of the dynamic shear test based on DIN EN 14293

| | | Mean value of |
|---|---|---|
| Example | | shear strength in |
| formulation | Storage | N/mm² |
| V1 | A | 0.09 |
| | B | 0.19 |
| | C | 0.41 |
| | D | 0.57 |
| | E | 0.70 |
| V2 | A | 0.13 |
| | B | 0.33 |
| | C | 0.81 |
| | D | 1.00 |
| | E | 1.00 |
| V3 | A | 0.09 |
| | B | 0.22 |
| | C | 1.02 |
| | D | 1.1 |
| | E | 1.1 |
| V4 | A | 0.21 |
| | B | 0.39 |
| | C | 0.71 |
| | D | 1.00 |
| | E | 1.00 |
| V5 | A | 0.11 |
| | B | 0.21 |
| | C | 0.50 |
| | D | 0.50 |
| | E | 0.60 |
| P1 | A | 0.51 |
| | B | 0.90 |
| | C | 1.70 |
| | D | 2.30 |
| | E | 2.40 |
| V6 | A | 0.19 |
| | B | 0.39 |
| | C | 0.66 |
| | D | 1.0 |
| | E | 1.2 |
| V7 | A | 0.13 |
| | B | 0.21 |
| | C | 0.79 |
| | D | 0.8 |
| | E | 0.9 |
| V8 | A | 0.20 |
| | B | 0.30 |
| | C | 0.75 |
| | D | 0.90 |
| | E | 1.0 |
| V9 | A | 0.2 |
| | B | 0.27 |
| | C | 0.67 |
| | D | 0.7 |
| | E | 0.7 |
| V10 | A | 0 |
| | B | 0 |
| | C | 0 |
| | D | 0 |
| | E | not |
| | | crosslinked |

The test results show that higher shear strengths are achieved by examples V2-V4 and V6-V8 according to the invention than by comparative examples V9 and V10 (final strengths). In addition, a more rapid buildup of strength is achieved by the examples according to the invention even when a catalyst is not used. By suitable formulation or variation of the polymerization composition, it is possible to realize even higher final strengths (P1) in combination with good processibility.

1. An adhesive comprising the following components:
(A) a polyacrylate resin comprising at least one silicon-comprising copolymer of:
a) 80-99.9 wt. % of monomer A comprising C₁-C₂₀-alkyl (meth)acrylates;
b) 0.1-20 wt. % of monomer B comprising at least one ethylenically unsaturated acid anhydride or one ethylenically unsaturated dicarboxylic acid whose carboxyl groups can form an anhydride groups, or
0.1-10 wt. % of monomer C comprising at least one isocyanate group and capable of free radical polymerization;
c) 0-30 wt. % of monomer D comprising one or more ethylenically unsaturated monomers capable of free radical polymerization; and
d) at least one silane of the general formula I, II or III
NHR₄—R₁—Si(R₂)₃₋ₘ(R₃)ₘ (I)
SH—R₁—Si(R₂)₃₋ₘ(R₃)ₘ (II)
R₅—R₁—Si(R₂)₃₋ₘ(R₃)ₘ (III)
wherein
m is the number 0, 1 or 2,
R₁ is a hydrocarbon chain having up to 10 carbon atoms which may be interrupted by oxygen or nitrogen,
R₂ are identical or different hydrolyzable groups,
R₃ are identical or different C₁-C₅-alkyl groups,
R₄ is a hydrogen radical or a hydrocarbon chain having up to 10 carbon atoms which may comprise oxygen or nitrogen, and
R₅ is an epoxide radical 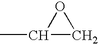
or a 3,4-epoxycyclohexyl radical;
(B) fillers;
(C) assistants; and
(D) 0-60 wt. % of plasticizers.

2. The adhesive according to claim 1, wherein the content of the polyacrylate resin A) is 20-100 wt. %.

3. The adhesive according to claim 1, wherein the content of the polyacrylate resin A) is 30-70 wt. %.

4. The adhesive according to claim 1, wherein the adhesive has a K value of from 1 to 100.

5. The adhesive according to claim 1, wherein the adhesive is selected from a construction adhesive, a component bonding adhesive, a parquet adhesive, and an assembly adhesive.

6. A construction adhesive comprising the adhesive according to claim 1.

7. A component bonding adhesive comprising the adhesive according to claim 1.

8. A parquet adhesive comprising the adhesive according to claim 1.

9. An assembly adhesive comprising the adhesive according to claim 1.

10. A method for preparing the adhesive according to claim 1, wherein the method comprises mixing the components in the absence of moisture to produce the adhesive in the form of a one-component system.

11. A method for preparing the adhesive according to claim 1, wherein the method comprises mixing the silane component into a previously prepared mixture, which comprises the assistants and monomer components in the absence of the silane component, to produce the adhesive in the form of a two-component system.
